(19) United States
(12) Patent Application Publication
(10) Pub. No.: US 2025/0060893 A1
(43) Pub. Date: Feb. 20, 2025

(54) TRACKING LATCH UPSET EVENTS USING BLOCK STATUS DATA

(71) Applicant: Micron Technology, Inc., Boise, ID (US)

(72) Inventors: John M. Gonzales, Boise, ID (US); Christopher G. Wieduwilt, Boise, ID (US); Seth A. Eichmeyer, Boise, ID (US); Matthew D. Jenkinson, Boise, ID (US)

(21) Appl. No.: 18/781,102

(22) Filed: Jul. 23, 2024

Related U.S. Application Data
(60) Provisional application No. 63/519,588, filed on Aug. 15, 2023.

(51) Int. Cl. G06F 3/06

(52) U.S. Cl. CPC G06F 3/064; G06F 3/0604; G06F 3/0679

(57) ABSTRACT

Apparatuses, systems, and methods for tracking latch upset events using block status data are described. An example method includes tracking a block status of each of a plurality of blocks of a first memory device by storing a first set of block status data that indicates a status of each block of the plurality of blocks in the first memory device and storing a second set of block status data that indicates a status of each block of the plurality of blocks in a location. The example method further includes comparing the first set of block status data to the second set of block status data.

### PRIORITY INFORMATION

This application claims the benefit of U.S. Provisional Application No. 63/519,588, filed on Aug. 15, 2023, the contents of which are incorporated herein by reference.

### TECHNICAL FIELD

Embodiments of the disclosure relate generally to semiconductor memory apparatuses, systems, and methods, and, more particularly, to apparatuses, systems, and methods related to tracking latch upset events using block status data.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), and synchronous dynamic random access memory (SDRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 illustrates an example computing environment that includes a memory sub-system in accordance with some embodiments of the present disclosure.

FIG. 2 is an example memory system for tracking latch upset events using block status data in accordance with some embodiments of the present disclosure.

FIG. 3 is a flow diagram of an example method for tracking latch upset events using block status data in accordance with some embodiments of the present disclosure.

FIG. 4 is a flow diagram of an example method for tracking latch upset events using block status data in accordance with some embodiments of the present disclosure.

FIG. 5 is a flow diagram of an example method for tracking latch upset events using block status data in accordance with some embodiments of the present disclosure.

FIG. 6 is a block diagram of an example computer system in which embodiments of the present disclosure may operate.

### DETAILED DESCRIPTION

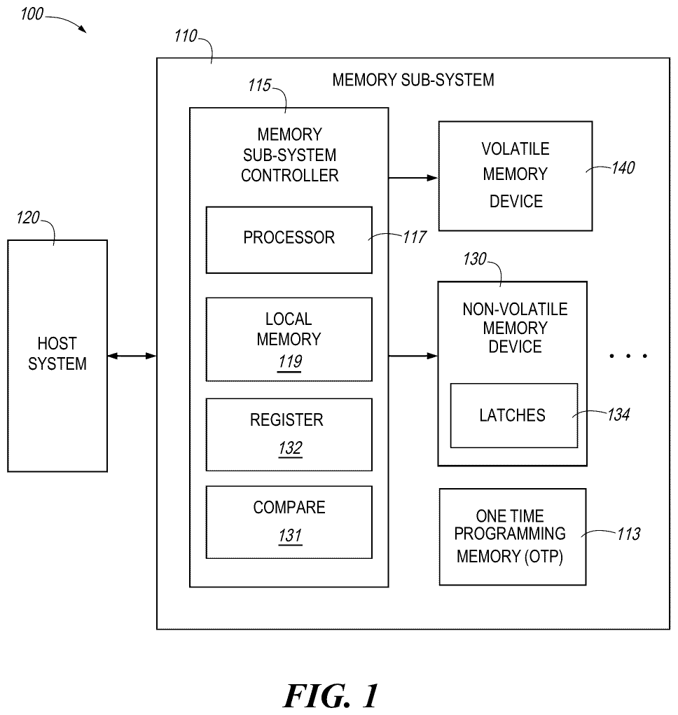

Apparatuses, systems, and methods for tracking latch upset events using block status data are described. A memory device can be a non-volatile memory device. One example of a non-volatile memory device is a flash memory system. Other examples of non-volatile memory devices are described below in conjunction with FIG. 1. A memory device can include a physical block of memory cells (e.g., a collection of data). The memory device can be coupled to a controller within a memory sub-system.

A memory sub-system can be a storage system, storage device, a memory module, or a combination of such. Examples of storage devices and memory modules are described below in conjunction with FIG. 1. In general, a host system can utilize a memory sub-system that includes one or more memory components (also hereinafter referred to as “memory devices”). The host system can provide data to be stored at the memory sub-system and can request data to be retrieved from the memory sub-system.

A memory operation (e.g., a read, write, or other memory operation) can be initiated to read data from and/or write data to store data in a memory device of the memory sub-system. A controller of the memory sub-system can access blocks of memory stored within a memory device and/or the data within the blocks of memory. The controller and/or the memory device can label the memory block as a bad block (e.g., the block is invalid, unable to properly store data, stores invalid data, etc.) or a good block (e.g., the block is valid, stores correct data, is still functioning properly, etc.) within block status data. The block status data can be stored in the controller and/or the memory device based on an indication from the memory device and/or a determination that the memory block is able to store correct data (e.g., label a good block) or not able to store correct data (e.g., label a bad block). For example, the block status data can indicate whether data within at least one memory block is valid or invalid. For instance, a block that is capable of holding data without introducing errors and/or an uncorrectable amount of errors can be designated as a good block, whereas a block that is prone to errors can be designated as a “bad” block.

The memory block can be labeled as a good block or a bad block within latches (e.g., CMOS latches) of the memory device. The memory device can store the block status data that indicates whether each block of a plurality of blocks is a good block or a bad block in an additional memory device (e.g., a one time programming (OTP) memory). The controller can store block status data in a register of the controller and/or, in some examples, in other locations within the memory and/or controller (e.g., such as within a lookup table (LUT)). The controller can reset the block status data associated with the blocks within the latches of the memory device by using the block status data stored in the additional memory (e.g., the OTP memory). The controller can then store the updated block status data which indicates whether one of the plurality of blocks is bad (e.g., the block status data) in the latches of the memory device.

In some instances, a latch upset event can cause one of the latches in the memory device to flip (e.g., store incorrect data about the status of a block of memory). As an example, a good block in the memory can be indicated as good in the block status data of the latches and a latch associated with the good block can be incorrectly flipped by the latch upset event, causing the good block to now be incorrectly indicated as a bad block in the latches. Such mislabeling can reduce a quantity of addressable blocks and therefore shorten an operational lifetime of a memory sub-system. Further, such mislabeling can prevent the memory device and/or controller from accessing data within the memory device and expend additional memory resources to either locate the data or retrieve the data from an additional location.

Aspects of the present disclosure address the above and other deficiencies by tracking latch upset events using block status data. In order to track possible latch upset events using block status data, the controller can compare block status data stored in the OTP memory to block status data stored in the memory device. In the alternative, the controller can compare block status data stored in a register of the controller to block status data stored in the memory device. In this way, a difference (e.g., a mismatch) in the block status data of either the controller and the memory device or the OTP memory and the memory device can indicate a latch upset event has occurred.

In order to correct a latch upset event, the controller can cause previously stored block status data in a one-time programmable memory to be transferred to the latches of the memory to correct the error in the block status data. A latch upset event can be caused by a neutron strike. As used herein, the term “neutron strike” refers to the interaction between one or more neutrons and a component of the memory device. The component can include, but is not limited to, an array of memory cells, latches, and logic circuitry. The errors can include, but are not limited to, changing the memory address stored in a latch or flipping a data bit. A processor on or coupled to the memory device can include error correction code (ECC) circuitry to correct the errors. However, if the number of errors exceeds the ability of the ECC circuitry to correct the errors, the memory device may function improperly.

FIG. 1 illustrates an example computing system 100 that includes a memory sub-system 110 in accordance with some embodiments of the present disclosure. The memory sub-system 110 can include media, such as one or more non-volatile memory devices (e.g., memory device 130). In other embodiments, the memory sub-system 110 can include volatile memory devices (e.g., memory device 140) and/or a combination of volatile memory devices and non-volatile memory devices.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130, 140) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random access memory (SDRAM). Some examples of non-volatile memory devices (e.g., memory device 130) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The memory device 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory device 130 can be grouped as pages that can refer to a logical unit of the memory device used to store data. With some types of memory (e.g., NAND), pages can be grouped to form blocks.

Although non-volatile memory components such as NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

In some embodiments, the memory sub-system 110 includes at least a portion of the OTP memory 113. For example, the memory sub-system controller 115 can communicate with the OTP memory 113 portion within the memory sub-system 110 to perform the operations described herein. Block status data can be stored in the OTP memory 113. Block status data can indicate whether a particular block of memory in the memory device 130, 140 is a good block or a bad block.

The memory sub-system controller 115 (or controller 115 for simplicity) can communicate with the memory devices 130, 140 to perform operations such as reading data, writing (e.g., program) data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. For example, the processor 117 (e.g., processing device) can be configured to execute instructions stored in local memory 119 for performing the operations described herein to read and/or write to the blocks of memory within the memory device 130 and/or read from the OTP 113.

The memory sub-system controller 115 can include a register 132 that stores block status data. The block status data stored in the register 132 can indicate whether a block in the memory device, 130, 140 is a good block or a bad block. The register 132 can store block status data that was transferred or written from block status data in the memory device 130. The memory device 130 can store the block status data in latches 134 of the memory device 130 (e.g., such as CMOS latches). In some examples, the block status data stored in the register 132 is the same as the block status data in the latches 134. In some examples, the block status data stored in the latches 134 has been corrupted or has experienced a latch upset event, as described herein. The latch upset event can cause the block status data stored in the latches 134 to be corrupted or to have a latch flip or store data different from the block status data stored in the register 132. The OTP memory 113 can store block status data that does not change and/or that is not corruptible. In response to the block status data in the register 132 being different from the block status data in the latches 134, block status data stored in the OTP memory 113 can be loaded into the latches 134 to remedy the error that was introduced by the latch upset event.

The memory sub-system controller 115 can include a compare component 131. The compare component 131 can include hardware, firmware, and/or circuitry used to compare block status data stored in various locations. For example, block status data can be stored in the register 132 of the controller, latches 134 of the memory device 130, and/or in the OTP memory 113. The block status data stored in at least two of the locations can be compared to determine if at least a portion of the block status data stored in one of the locations has been corrupted or includes an error.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130, 140. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller for media management within the same memory device package. An example of a managed memory device is a managed NAND (MNAND) device.

The non-volatile memory device 130 can store a plurality of physical blocks of memory cells (e.g., a collection of data). The controller 115 can label the plurality of physical blocks of memory cells within block status data to indicate the validity of at least one memory block. The block status data can be stored within the OTP memory device 113 within the non-volatile memory device 130 using latches. For example, the OTP memory device 113 can include one or more latches that are configured to store an indication whether a block of the plurality of blocks of memory is a “good” block or a “bad” block. For example, the latch can store a “1” for a good block and a “0” for a bad block, etc. Although not shown in FIG. 1 so as to not obfuscate the drawings, the OTP memory device 113 can include various circuitry to facilitate data storage. For example, the OTP memory device 113 can include special purpose circuitry in the form of an ASIC, FPGA, state machine, and/or other logic circuitry that can allow the OTP memory device 113 to store memory block tags.

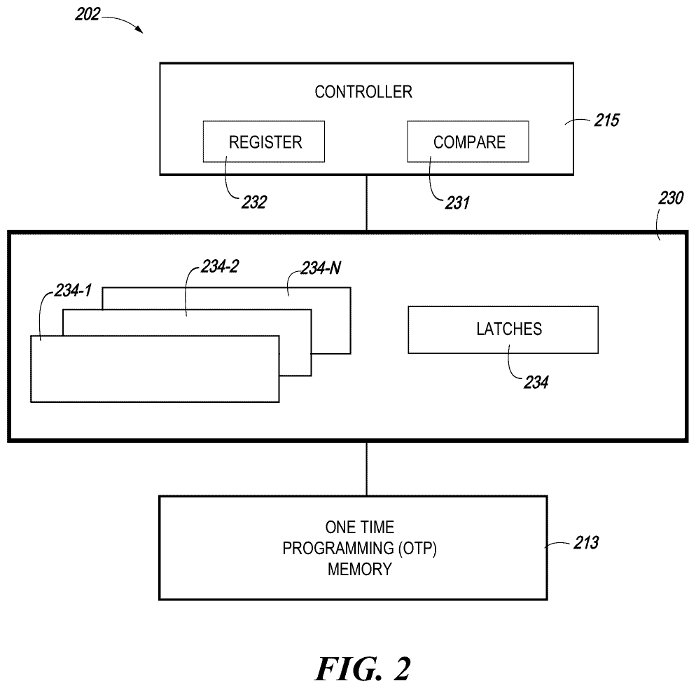

The stored block status data within the OTP memory device 113 can be compared to the block status data stored in the register 132 of the controller 115. In some examples, the comparison of block status data in the controller 115 to block status data in the memory device 130 can occur whenever the controller 115 tags a memory block as a bad block. Further, the comparison can occur at particular time intervals or time periods thereby tracking the occurrence of latch upset events in a repeating pattern. In the event that the comparison of block status data in the OTP 113 with block status data in the memory device 130 determines a match, the block status data in the memory device 130 can be considered valid (and thereby not need to be loaded or written over by the block status data in the OTP 113). Likewise, in the event that the comparison does not determine a match, the block status data can be considered invalid and the block status data stored in the memory device can be written over by the block status data in the OTP 113. FIG. 2 is an example memory system 202 for tracking latch upset events using block status data in accordance with some embodiments of the present disclosure. The example memory system 202 can include a memory sub-system controller 215. The memory sub-system controller 215 can label memory blocks 234-1, 234-2, . . . , 234-N(hereinafter referred to collectively as memory blocks 234) within the non-volatile memory device 230 as good blocks or bad blocks and store the block status data within the OTP memory device 213 (e.g., analogous to the OTP memory device 113 illustrated in FIG. 1) and/or within latches 234 (e.g., CMOS latches) of the memory device 230. Although only one portion of blocks of memory cells is illustrated, embodiments are not so limited and an unlimited amount of portions of blocks of memory may be within the non-volatile memory device, whose block status data can be stored partially or entirely within the OTP memory device 213. The block status data can indicate the validity of each memory block. For example, the block status data can indicate whether a block is a good block or a bad block, e.g., whether the controller can read, erase, program or write data to the memory block 234 without generating or inserting errors (e.g., without incurring an amount of errors that exceeds an error correction capability associated with the memory device 213).

A latch upset event can be defined as an occurrence that causes a latch to become inadvertently enabled. For example, the latch upset event can flip a latch of the memory device 230 that indicates whether a particular block in the memory device 230 is a bad block or a good block. A latch upset event can prevent the controller 215 from accessing data within the particular block due to the latches 234 of the memory device 230 incorrectly indicating that the particular block is a bad block. For example, a bad block can be added to a bad block list/lookup table (LUT) and no block on the bad block list/LUT are addressable and/or able to therefore have data written thereto or read therefrom.

The controller 215 can include a compare component 231 (e.g., analogous to compare component 131 in FIG. 1). The compare component 231 can be used to compare different block status data stored in different locations. For example, the block status data stored in the register 232 of the controller 215 can be compared to the block status data stored in the latches 234 of the memory device 130 by the compare component 231. Further, the block status data stored in the OTP memory 213 can be compared to the block status data stored in the latches 234 of the memory device 130 by the compare component 231. In this way, the block status data in the latches 234 can be verified to be correct or incorrect and/or the occurrence of a latch upset event can be determined.

A comparison of the block status data can indicate that a latch upset event occurred. For example, when there is a difference between the block status data of the memory block to be erased and the block status data of the OTP memory device 213, a determination that an error has occurred can be made. In one example, a latch upset event can be caused by silicon particles colliding with neutrons (e.g., referred to as a neutron strike) of a latch within the memory device 230. The silicon particle can attract a charge and change the data within the latch. In another example, a latch upset event can be caused by alpha particles colliding with neutrons of the latch. But embodiments are not so limited, any occurrence that causes a collision with neutrons of the latch can cause a latch upset event. In response to the comparison of the block status data at different locations being different values, a flag can be set by the controller 215. Further, a reloading or a writing over of the block status data in the latches 234 of the memory device 230 can be performed by transferring the block status data stored in the OTP 213 to the latches 234.

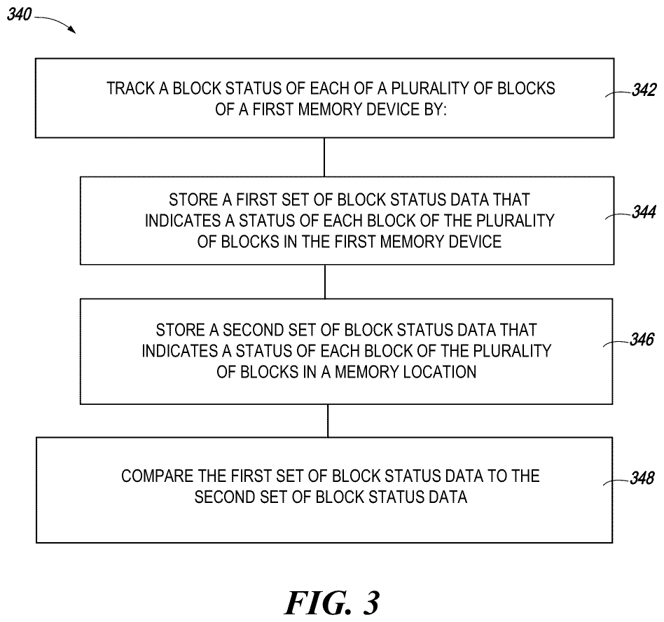

FIG. 3 is a flow diagram of an example method 340 corresponding to tracking latch upset events using block status data in accordance with some embodiments of the present disclosure. The method 340 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 340 can be performed by the memory sub-system controller 115 and 215 of FIGS. 1-2 respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 342, the method 340 includes tracking a block status of each of a plurality of blocks of a first memory device. The first memory device can be a non-volatile memory (NVM) device, such as NVM device 130 and 230 in FIGS. 1-2. The block status can refer to whether the block is a good block or a bad block. The block status can be stored in block status data, which refers to data that indicates the block status and therefore indicates whether a particular block is a good block or a bad block. In some examples, tracking the block status of each of the plurality of blocks can include updating block status data of the first set of block status data associated with a block of the plurality of blocks in response to the block status of one or more of the plurality of blocks changing. For example, in response to the block status of a block changing, e.g., a block changing from a good block to a bad block, the block status data associated with that block that has changed can be updated to indicate the block is now a bad block.

At operation 344, the tracking of the block status of each of the plurality of blocks of the first memory device can be performed by storing a first set of block status data that indicates each respective block status in the first memory device. As an example, the block status data can be stored in the first memory device in latches (e.g., CMOS latches). At operation 346, the tracking of the block status of each of the plurality of blocks of the first memory device can be performed by storing a second set of block status data that indicates each respective block status in a memory location. In some examples, the memory location can refer to a register of a controller used to store the block status data. In some examples, the memory location can be a location in an OTP memory.

At operation 348, the method 340 can include comparing the first set of block status data to the second set of block status data. As an example, block status data stored in the latches of the memory device can be compared to block status data stored in the register of the controller. Further, block status data stored in the latches of the memory device can be compared to block status data stored in the OTP memory. In this way, the block status data in the memory device can be compared to the block status in either of the controller or the OTP memory to determine whether a latch upset event has occurred and/or determine whether to reload the block status data from the OTP memory into the latches of the memory device and/or into the register of the controller.

In some examples, in response to the first set of block status data matching the second set of block status data, the first set of block status data is maintained as is. As an example, the first set of block status data is not written over by additional data or changed to correct corrupted data based on a latch upset event changing the first set of block status data. In some examples, in response to the first set of block status data being different than the second set of block status data, the first set of block status data is written over with the second set of block status data. In some examples, an occurrence of a latch upset event can be determined in response to the first set of block status data not matching the second set of block status data. In some examples, in response to determining that the latch upset event has occurred, a flag can be set (e.g., a bit can be flipped to indicate a latch upset event has occurred). In some examples, determining that a latch upset event has occurred can include determining that a neutron strike on the first set of block status data has occurred. In some examples, the first set of block status data is stored within complementary metal-oxide semiconductor (CMOS) latches of the first memory device.

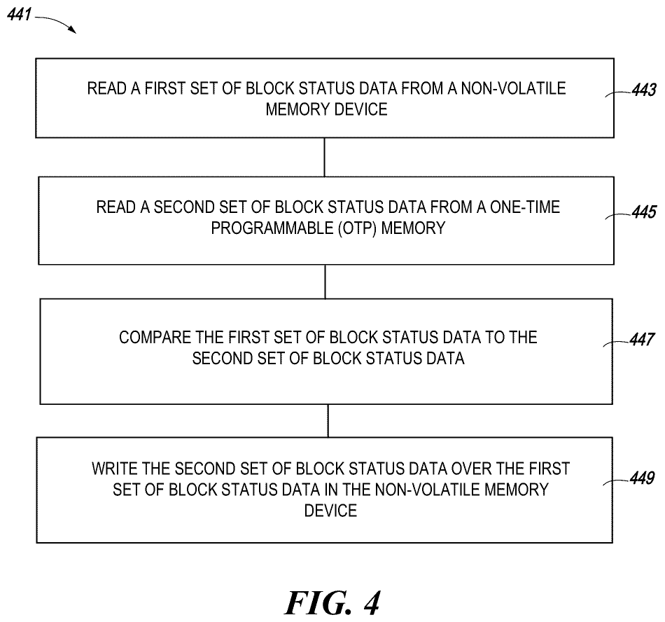

FIG. 4 is a flow diagram of an example method 441 corresponding to tracking latch upset events using block status data in accordance with some embodiments of the present disclosure. The method 441 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 441 can be performed by the memory sub-system controller 115 and 215 of FIGS. 1-2, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 443, the method 441 includes reading a first set of block status data from a non-volatile memory device. The non-volatile memory device can be analogous to the non-volatile memory (NVM) device 130 and 230 in FIGS. 1-2. The block status data can indicate whether a particular block in the memory device is a good block or a bad block. In some examples, the first set of block status data is stored in complementary metal-oxide semiconductor (CMOS) latches of the non-volatile memory device.

At operation 445, the method 441 includes reading a second set of block status data from an OTP memory. The OTP memory can be analogous to the OTP memory 113 and 213 in FIGS. 1-2. At operation 447, the method 441 includes comparing the first set of block status data to the second set of block status data. In some examples, the controller can cause the setting of a flag to indicate an occurrence of a neutron strike in response to the first set of block status data being different than the second set of block status data. The setting of a flag can refer to a bit of data being changed to indicate that a neutron strike has occurred. The flag can be accessible by a user of the data, a system monitoring the data, etc. In response to detecting a set flag, additional measures can be taken to correct the neutron strike occurrence or to determine that a grouping of neutron strikes or a pattern of neutron strikes may be caused by a specific event or series of events that may need to be addressed. Conversely, an absence of a neutron strike on the non-volatile memory can be determined responsive to the first set of block status data matching the second set of block status data.

At operation 449, the method 441 includes writing the second set of block status data over the first set of block status data in the non-volatile memory device. For instance, the second set of block status data can be written over the first set of block status data in response to the first set of block status data being different than the second set of block status data, based on the comparison at 447.

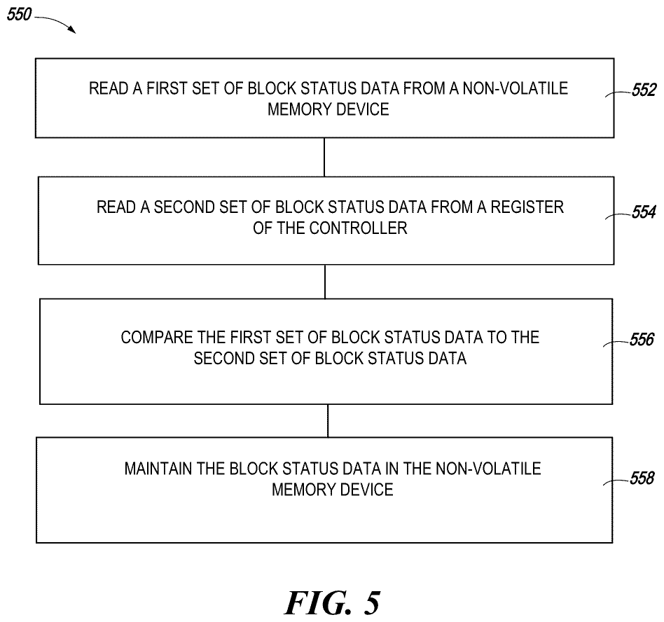

FIG. 5 is a flow diagram of an example method 550 corresponding to tracking latch upset events using block status data in accordance with some embodiments of the present disclosure. The method 550 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 550 can be performed by the memory sub-system controller 115 and 215 of FIGS. 1-2, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 552, the method 550 includes reading a first set of block status data from a non-volatile memory device. The non-volatile memory device can be analogous to the non-volatile memory (NVM) device 130 and 230 in FIGS. 1-2. The block status data can indicate whether a particular block in the memory device is a good block or a bad block. In some examples, the controller can prevent access to any block of memory that is determined to be a bad block based on the block status data.

At operation 554, the method 550 includes reading a second set of block status data from a register of a controller. The register can be analogous to register 132 and 232 in FIGS. 1-2. The controller can be analogous to the controller 115 and 215 in FIGS. 1-2. At operation 556, the method 550 includes comparing the first set of block status data to the second set of block status data. In some examples, the controller can be configured to, in response to the first set of block status data being different than the second set of block status data, access block status data stored in an OTP memory. In some examples, the controller can, in response to the first set of block status data being different than the second set of block status data, write the block status data accessed from the OTP memory over the first set of block status data.

At operation 558, the method 550 includes maintaining the block status data in the non-volatile memory device. Maintaining the block status data can refer to not writing over or not changing the block status data in response to the result of comparing the first set of block status data to the second set of block status data. The block status data can be maintained in response to the first set of block status data matching the second set of block status data. In response to the first set being different than the second set, the second set of block status data can be written over the first set of block status data in the non-volatile memory device. In some examples, the controller can be configured to determine that a neutron strike has occurred in response to the first set of block status data being different than the second set of block status data.

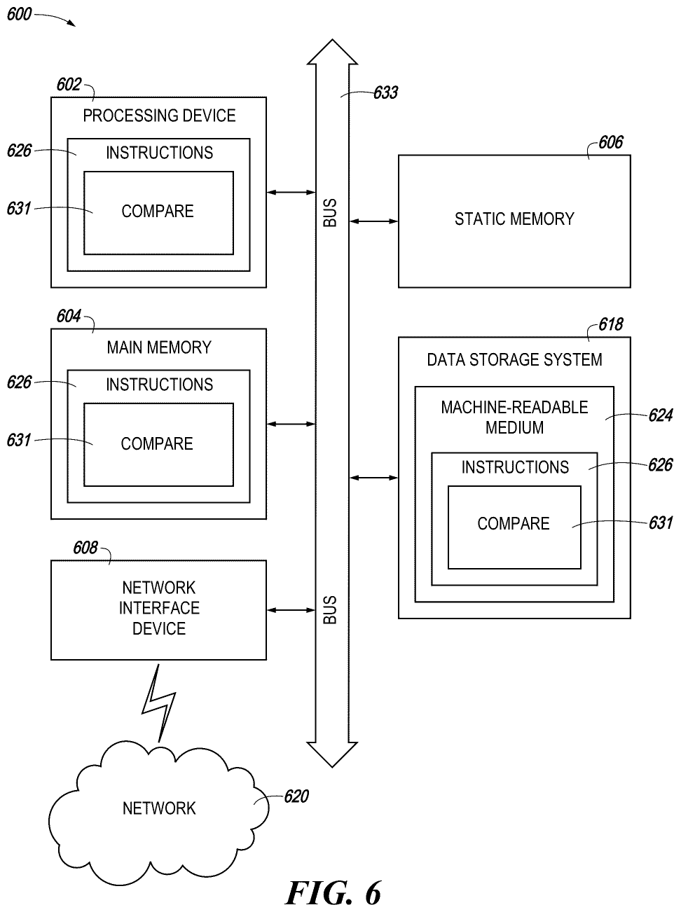

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to tag memory blocks) and of the compare component 631 (e.g., to compare block status data stored in different locations that indicates the validity of the memory blocks within the non-volatile memory). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 633. The processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and stages discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality using data stored in the OTP memory device 613. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
tracking a block status of each of a plurality of blocks of a first memory device by:
storing a first set of block status data that indicates a status of each block of the plurality of blocks in the first memory device; and
storing a second set of block status data that indicates a status of each block of the plurality of blocks in a memory location; and
comparing the first set of block status data to the second set of block status data.

2. The method of claim 1, wherein the first memory device is a non-volatile memory device and the memory location is within a one-time programmable (OTP) memory.

3. The method of claim 1, wherein the location is a controller and the controller is configured to store the second set of block status data in a register of the controller.

4. The method of claim 1, wherein tracking the block status of each of the plurality of blocks comprises updating block status data of the first set of block status data associated with a block of the plurality of blocks in response to the block status of the block changing.

5. The method of claim 4, wherein the block status of the block changing comprises the block changing from a good block to a bad block.

6. The method of claim 1, comprising, in response to the first set of block status data matching the second set of block status data, maintaining the first set of block status data as is.

7. The method of claim 1, comprising, in response to the first set of block status data being different than the second set of block status data, writing over the first set of block status data with the second set of block status data.

8. The method of claim 1, comprising determining that a latch upset event has occurred in response to the first set of block status data not matching the second set of block status data.

9. The method of claim 8, comprising, in response to determining that the latch upset event has occurred, setting a flag.

10. The method of claim 8, wherein determining that the latch upset event has occurred comprises determining that a latch upset event on the first set of block status data has occurred.

11. The method of claim 1, wherein the first set of block status data is stored within complementary metal-oxide semiconductor (CMOS) latches of the first memory device.

12. An apparatus, comprising:
a non-volatile memory comprising a plurality of blocks of memory; and
a controller coupled to the non-volatile memory and configured to:
read a first set of block status data from a non-volatile memory device, wherein the first set of block status data indicates a status of each block of the plurality of blocks in the non-volatile memory device;
read a second set of block status data from a one-time programmable (OTP) memory, wherein the second set of block status data indicates the status of each block the plurality of blocks of memory;
compare the first set of block status data to the second set of block status data; and
in response to the first set of block status data being different than the second set of block status data, write the second set of block status data over the first set of block status data in the non-volatile memory device.

13. The apparatus of claim 12, wherein the first set of block status data is stored in complementary metal-oxide semiconductor (CMOS) latches of the non-volatile memory device.

14. The apparatus of claim 12, wherein the controller is configured to set a flag indicating occurrence of a latch upset event in response to the first set of block status data being different than the second set of block status data.

15. The apparatus of claim 12, comprising, in response to the first set of block status data matching the second set of block status data, determining an absence of a latch upset event on the non-volatile memory device.

16. An apparatus comprising:
a non-volatile memory comprising a plurality of blocks of memory; and
a controller coupled to the non-volatile memory comprising a register, the controller configured to:
read a first set of block status data from a non-volatile memory device, wherein the first set of block status data indicates a status of each block of the plurality of blocks in the non-volatile memory device;
read a second set of block status data from a register of the controller, wherein the second set of block status data indicates the status of each block of the plurality of blocks of memory;
compare the first set of block status data to the second set of block status data; and
in response to the first set of block status data matching the second set of block status data, maintain the block status data in the non-volatile memory device.

17. The apparatus of claim 16, wherein the controller is configured to prevent access to any block of memory that is determined to be a bad block based on the block status data.

18. The apparatus of claim 16, wherein the controller is configured to, in response to the first set of block status data being different than the second set of block status data, access block status data stored in a one-time programmable (OTP) memory.

19. The apparatus of claim 18, wherein the controller is further configured to write the block status data accessed from the OTP memory over the first set of block status data.

20. The apparatus of claim 16, wherein the controller is configured to infer that a latch upset event has occurred in response to the first set of block status data being different than the second set of block status data.
